(19) United States
(12) Patent Application Publication
(10) Pub. No.: US 2025/0102441 A1
(43) Pub. Date: Mar. 27, 2025

(54) Electronic Devices With Relative Humidity Sensors

(71) Applicant: Apple Inc., Cupertino, CA (US)

(72) Inventors: Fehmi Civitci, Carlsbad, CA (US); David D. Dashevsky, San Jose, CA (US); Christopher M. Dodson, Denver, CO (US); Kenneth J. Vampola, Los Altos, CA (US); Mark T. Winkler, Menlo Park, CA (US); Dawei Lu, Campbell, CA (US)

(21) Appl. No.: 18/754,521

(22) Filed: Jun. 26, 2024

Related U.S. Application Data
(60) Provisional application No. 63/585,827, filed on Sep. 27, 2023.

(51) Int. Cl. G01N 21/77; G01N 29/02; G01N 29/24

(52) U.S. Cl. CPC G01N 21/77; G01N 29/02; G01N 29/2418; G01N 2021/7773

(57) ABSTRACT

An electronic device may include a housing and relative humidity sensor in the housing. The relative humidity sensor may include a relative humidity-sensitive layer, a light emitter that emits light into the relative humidity-sensitive layer, and a light detector that detects light that has passed through the relative humidity-sensitive layer. The relative humidity may be determined based on the detected light. For example, the light may be measured interferometrically to determine a path length of the light to determine the relative humidity. Alternatively, the light may be scattered by plasmonic nanoparticles in a relative humidity-sensitive material to determine the relative humidity. As other examples, polarized light may pass through the relative humidity-sensitive layer and measured to determine the relative humidity, or light may be used to form sound waves that may be measured to determine the relative humidity. In this way, a light-based relative humidity-sensor may make relative humidity measurements.

This application claims the benefit of U.S. provisional patent application No. 63/585,827, filed Sep. 27, 2023, which is hereby incorporated by reference herein in its entirety.

### FIELD

This relates generally to electronic devices, and, more particularly, to electronic devices with environmental sensors.

### BACKGROUND

Electronic devices such as laptop computers, cellular telephones, and other equipment are sometimes provided with environmental sensors, such as ambient light sensors, image sensors, and microphones.

### SUMMARY

An electronic device, such as a wristwatch device or other wearable electronic device, may include a housing and a display in the housing. The electronic device may also include a relative humidity sensor in the housing. For example, the housing may have an opening, and the relative humidity sensor may be overlapped by the opening to receive moisture from an exterior of the device.

The relative humidity sensor may include a relative humidity-sensitive layer, a light emitter that emits light into the relative humidity-sensitive layer, and a light detector that detects light that has passed through the relative humidity-sensitive layer. The relative humidity-sensitive layer may have at least one property, such as refractive index, that changes in response to relative humidity changes. Therefore, the relative humidity may be determined based on the detected light.

For example, the light may be measured interferometrically to determine a path length of the light to determine the relative humidity. Alternatively, the light may be scattered by plasmonic nanoparticles in a relative humidity-sensitive material to determine the relative humidity. As other examples, polarized light may pass through the relative humidity-sensitive layer and measured to determine the relative humidity, or light may be used to form sound waves that may be measured to determine the relative humidity. In this way, a light-based relative humidity-sensor may make relative humidity measurements.

### BRIEF DESCRIPTION OF THE DRAWINGS

FIG. 1 is a perspective view of an illustrative wearable electronic device in accordance with some embodiments.

FIG. 2 is a perspective view of an illustrative portable electronic device in accordance with some embodiments.

FIG. 3 is a diagram of an illustrative electronic device in accordance with some embodiments.

FIG. 4 is a side view of an illustrative electronic device with a relative humidity sensor that measures relative humidity interferometrically in accordance with some embodiments.

FIG. 5 is a side view of an illustrative electronic device with a relative humidity sensor that measures relative humidity based on light scattering by nanoparticles in accordance with some embodiments.

FIG. 6 is a graph of illustrative an illustrative shift in the power of scattered light by nanoparticles in a relative humidity sensor due to a change in relative humidity in accordance with some embodiments.

FIG. 7 is a side view of an illustrative electronic device with a relative humidity sensor that measures relative humidity based on the polarization of light in a relative humidity-sensitive layer in accordance with some embodiments.

FIG. 8 is a side view of an illustrative electronic device with a relative humidity sensor that measures relative humidity based on sound waves that are generated by light traveling through a water absorption layer in accordance with some embodiments.

### DETAILED DESCRIPTION

Electronic devices are often carried by users as they conduct their daily activities. For example, a user may carry an electronic device on their person throughout the day while walking, commuting, working, exercising, etc. In some situations, it may be desirable for the user to know the relative humidity in the device's environment. For example, relative humidity may be used in combination with fitness applications (e.g., to determine whether a user is suffering from hypothermia, which is more likely at high relative humidity levels), weather sensing and/or forecasting, and/or or other desired functions.

To make relativity humidity measurements, the electronic device may include a relative humidity sensor. The relative humidity sensor may include a light source, a relative humidity-sensitive layer through which the light source emits light, and a light detector. The relative humidity-sensitive layer may change the behavior of the light prior to the light reaching the light detector. For example, at different relative humidity levels, the relative humidity-sensitive coating may have different refractive indexes. Therefore, the relative humidity may be determined based on the amount/intensity of the light that reaches the light detector.

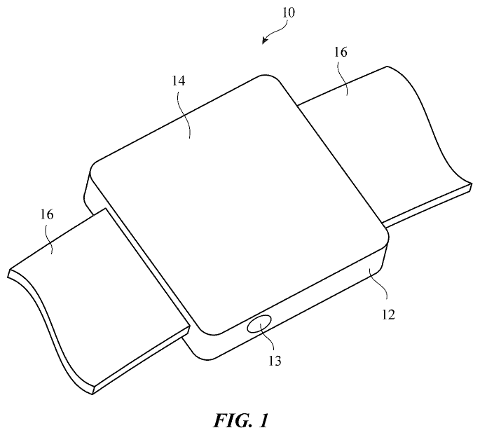

In general, any suitable electronic devices may include a relative humidity sensor. As shown in FIG. 1, a wearable electronic device 10, which may be a wristwatch device, may have a housing 12, a display 14, and a strap 16. In particular, display 14 may be on a front face of wearable device 10. The wristwatch may attach to a user's wrist via strap 16. When worn on the user's wrist, a rear face of wearable device 10 (i.e., a rear surface of housing 12) may contact or be oriented toward the user's wrist. In some embodiments, device 10 may include various sensors that are in contact with the user's wrist, and the sensors may gather health or activity data (e.g., heart rate data or blood oxygen data) of the user. Additionally or alternatively, device 10 may include opening 13. Opening 13 may allow moisture to pass through a wall of housing 12 (e.g., a sidewall of housing 12), allowing a relative humidity sensor to determine the relative humidity outside of device 10. Opening 13 may be covered with a mesh or other material, or may be uncovered.

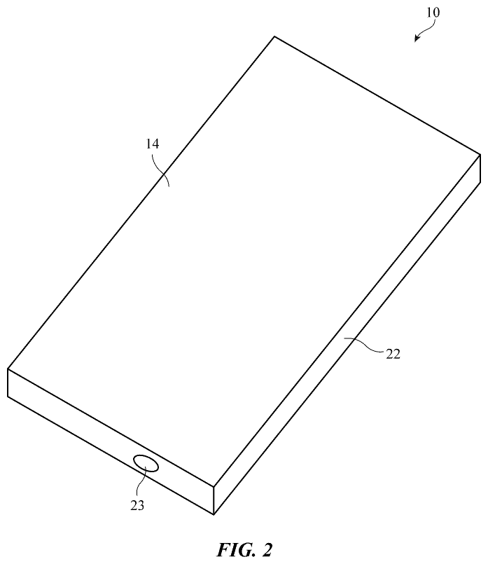

Although FIG. 1 shows electronic device 10 shown as a wristwatch device, this is merely illustrative. In general, electronic device 10 may be any desired device. For example, in the illustrative example of FIG. 2, device 10 may be a cellular telephone (e.g., a smartphone) having display 14 on a front face of housing 22, as well as opening 23 for a relative humidity sensor on a sidewall of housing 22. Alternatively, device 10 may be a media player (e.g., a smart speaker), or other handheld or portable electronic device, a laptop computer, a desktop computer, a wristband device, a pendant device, a headphone, a speaker, a smart speaker, an ear bud or earpiece device, a head-mounted device such as glasses, goggles, a helmet, or other equipment worn on a user's head, or other wearable or miniature device, a navigation device, or other accessory, and/or equipment that implements the functionality of two or more of these devices.

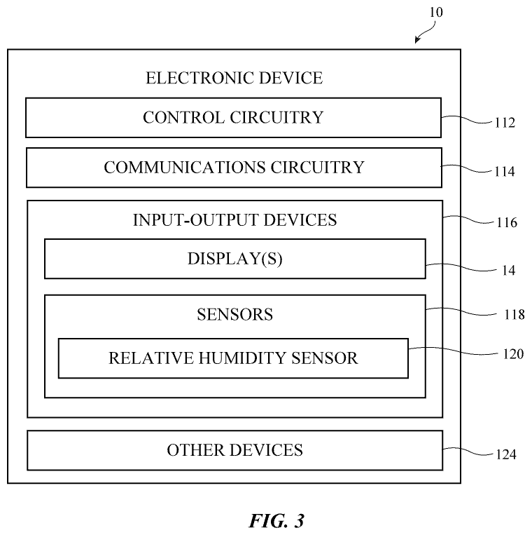

Illustrative configurations in which electronic device 10 is a portable electronic device such as a cellular telephone, head-mounted device, ear bud, wristwatch, or portable computer may sometimes be described herein as examples. Regardless of the form factor of device 10, an illustrative schematic diagram of device 10 is shown in FIG. 3.

As shown in FIG. 3, electronic devices such as electronic device 10 may have control circuitry 112. Control circuitry 112 may include storage and processing circuitry for controlling the operation of device 10. Circuitry 112 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 112 may be based on one or more microprocessors, microcontrollers, digital signal processors, baseband processors, power management units, audio chips, graphics processing units, application specific integrated circuits, and other integrated circuits. Software code may be stored on storage in circuitry 112 and run on processing circuitry in circuitry 112 to implement control operations for device 10 (e.g., data gathering operations, operations involving the adjustment of the components of device 10 using control signals, etc.).

Electronic device 10 may include communications circuitry 114, which may include wired and/or wireless communications circuitry. For example, electronic device 10 may include radio-frequency transceiver circuitry, such as cellular telephone transceiver circuitry, wireless local area network transceiver circuitry (e.g., Wi-Fi® circuitry), short-range radio-frequency transceiver circuitry that communicates over short distances using ultra high frequency radio waves (e.g., Bluetooth® circuitry operating at 2.4 GHz or other short-range transceiver circuitry), millimeter wave transceiver circuitry, and/or other wireless communications circuitry.

Device 10 may include input-output devices 116. Input-output devices 116 may be used to allow a user to provide device 10 with user input. Input-output devices 116 may also be used to gather information on the environment in which device 10 is operating. Output components in devices 116 may allow device 10 to provide a user with output and may be used to communicate with external electrical equipment.

Input-output devices 116 may include one or more optional displays such as displays 14. Displays 14 may be organic light-emitting diode displays or other displays with light-emitting diodes, liquid crystal displays, microLED displays, or other displays. Displays 14 may be touch sensitive (e.g., displays 14 may include two-dimensional touch sensors for capturing touch input from a user) and/or displays 14 may be insensitive to touch.

Input-output devices 116 may include sensors 118. Sensors 118 may include, for example, temperature sensors (e.g., thermistors or thermocouples), three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user's eyes), touch sensors, capacitive proximity sensors, light-based (optical) proximity sensors, other proximity sensors, force sensors, sensors such as contact sensors based on switches, gas sensors, pressure sensors, moisture sensors, magnetic sensors (e.g., a magnetometer), audio sensors (microphones), ambient light sensors, microphones for gathering voice commands and other audio input, sensors that are configured to gather information on motion, position, and/or orientation (e.g., accelerometers, gyroscopes, pressure sensors, compasses, and/or inertial measurement units that include all of these sensors or a subset of one or two of these sensors), health sensors that measure various biometric information (e.g., heartrate sensors, such as a photoplethysmography sensor), electrocardiogram sensors, and perspiration sensors) and/or other sensors.

Sensors 118 may also include one or more relative humidity sensors 120. Relative humidity sensor(s) 120 may be incorporated into device 10, and may measure a relative humidity at the exterior of electronic device 10

If desired, input-output devices 116 may include other devices 124 such as haptic output devices (e.g., vibrating components), light-emitting diodes and other light sources, speakers such as ear speakers for producing audio output, circuits for receiving wireless power, circuits for transmitting power wirelessly to other devices, batteries and other energy storage devices (e.g., capacitors), joysticks, buttons, and/or other components.

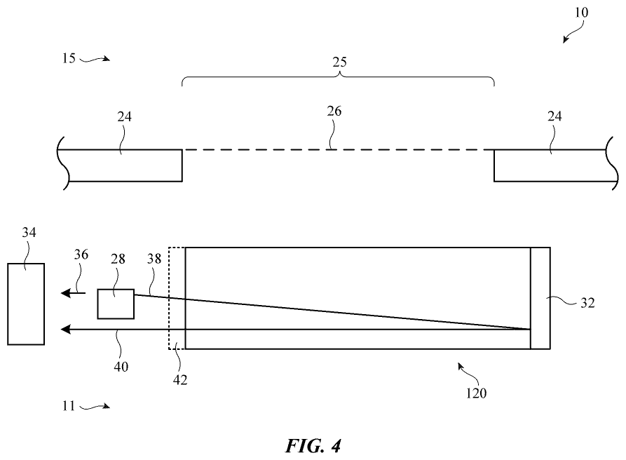

An illustrative example of a device having a relative humidity sensor is shown in FIG. 4. As shown in FIG. 4, device 10 may include relative humidity sensor 120. In particular, relative humidity sensor 120 may be positioned behind opening 25 of layer 24. Layer 24 may be a housing of device 10, such as housing 12 of FIG. 1 or housing 22 of FIG. 2. Alternatively, layer 24 may be another layer that overlaps relative humidity sensor 120 and separates interior 11 from exterior 15. Opening 25, which may correspond with opening 13 of FIG. 1 or opening 23 of FIG. 2, may allow moisture from the environment at exterior 15 to reach relative humidity sensor 120 in interior 11. Opening 25 may overlap sensor 120, as shown in FIG. 4, or sensor 120 may be partially or entirely offset from opening 25. In other words, relative humidity sensor 120 may be in interior 11 and may be exposed to the environment at exterior 15. Protective mesh 26 may be included in opening 25 to protect relative humidity sensor 120 and/or other components in interior 11 from various particulate or other intrusive materials. Protective mesh 26 may be a metal mesh, a polymer mesh, or a mesh of any other suitable material. In some embodiments, protective mesh 26 may be coated with a hydrophobic material to protect sensor 120 from liquid water, while allowing sensor 120 to change one or more properties due to relative humidity changes at exterior 15.

Relative humidity sensor 120 may include light emitter 28 (also referred to as light source 28 herein), which may be a laser diode, a light-emitting diode, or any other desired light emitter. Sensor 120 may also include light detector 34, which may be a photodiode or other light-sensitive device. Moreover, relative humidity sensor 120 may include relative humidity-sensitive layer 30, and mirror coating 32 on an opposite side of relative humidity-sensitive layer 30 from light emitter 28. Mirror coating 32 may be formed from a reflective material, such as metal; a reflective coating, such as a stack of thin-film dielectric layers that have a reflectivity of at least 75%, at least 80%, at least 90% or other suitable reflectivity; or other suitable reflective material.

Light emitter 28 may emit light 38 into a first side of relative humidity-sensitive layer 30 (also referred to as relative-humidity sensitive material 30 herein). Relative humidity-sensitive layer 30 may be an inorganic porous film, which may include voids and/or nanoparticles. Layer 30 may have a thickness of at least 1 micron, between 1 micron and 100 microns, less than 150 microns, at least 50 microns, or other suitable thickness. The nanoparticles may be inorganic, such as silicon dioxide nanoparticles, titanium dioxide nanoparticles, zinc oxide nanoparticles, or other suitable nanoparticles. Relative humidity-sensitive layer 30 may exhibit refractive index changes in response to changes in relative humidity due to the presence of the nanoparticles and the voids.

As another example, relative humidity-sensitive layer 30 may be a polymer layer that exhibits changes in refractive index as the relative humidity changes.

Alternatively, relative humidity-sensitive layer 30 may be formed from a holographic layer. For example, relative humidity-sensitive layer 30 may be formed from a photopolymer, such as dichromate gelatin, in or on which a holographic pattern is recorded. The holographic pattern may be an interference pattern that includes a plurality of gratings and/or may include lenses or mirrors. The photopolymer may be sensitive to humidity and/or temperature, and may have a refractive index change or a thickness change at different relative humidities. When exposed to different relative humidity levels, the holographic interference pattern (e.g., the distance between gratings of the interference pattern) may therefore change, impacting the behavior of light through relative humidity-sensitive layer 30.

Regardless of the material used to form relative humidity-sensitive layer 30, light 38 may proceed through relative humidity-sensitive layer 30 and reflect off of mirror coating 32 on an opposite side of relative humidity-sensitive layer 30 from light emitter 28. Reflected light 40 may then be detected by light detector 34.

Light emitter 28 may also emit light 36 directly to light detector 34. By comparing light 36 to light 40, such as by measuring the optical path length of light 36 and light 40 interferometrically (e.g., with a self-mixing interferometer), the refractive index of relative humidity-sensitive layer 30 may be determined.

The refractive index of relative humidity-sensitive layer 30 may change as a function of the relative humidity. In particular, at low relative humidity, the refractive index of relative humidity-sensitive layer 30 may be relatively low, such as between 1.0 and 1.25, or other suitable value. However, as the relative humidity increases, water may increase the refractive index of layer 30, such as by building up on the surface of nanoparticles and/or filling voids in layer 30 (if layer 30 is formed from an inorganic porous film). In an illustrative embodiment, the refractive index of relative humidity-sensitive layer 30 may change from 1.38 to 1.43 as the relative humidity changes from 30% to 90%. However, this is merely illustrative. In general, the refractive index of layer 30 may change as a function of the relative humidity based on the material(s) that form layer 30.

As a result of the refractive index changes, the path length of light 40 will change relative to the path length of light 36, which has not passed through relative humidity-sensitive layer 30. The refractive index of relative humidity-sensitive layer 30, and therefore the relative humidity, may therefore be determined by comparing the path length of light 40 to the path length of light 36. In other words, relative humidity sensor 120 may determine the relative humidity directly based on the path length of light 40/36, or control circuitry (such as control circuitry 112 of FIG. 3) may be used to determine the relative humidity based on the measured path length. In this way, interferometry, such as self-mixing interferometry, may be used to determine the relative humidity.

Partial mirror coating 42 may optionally be incorporated on a surface of relative humidity-sensitive layer 30 opposite mirror coating 32. For example, partial mirror coating 42 may be formed from a stack of dielectric films with alternating refractive indexes. The stack may pass selected wavelengths of light, while partially blocking other wavelengths of light. In particular, partial mirror coating 42 may allow light 38 to pass into relative humidity-sensitive layer 30, while reflecting light within relative humidity-sensitive layer 30 additional times. This may extend the path length of light 38/40 and allow for more accurate and/or sensitive relative humidity measurements.

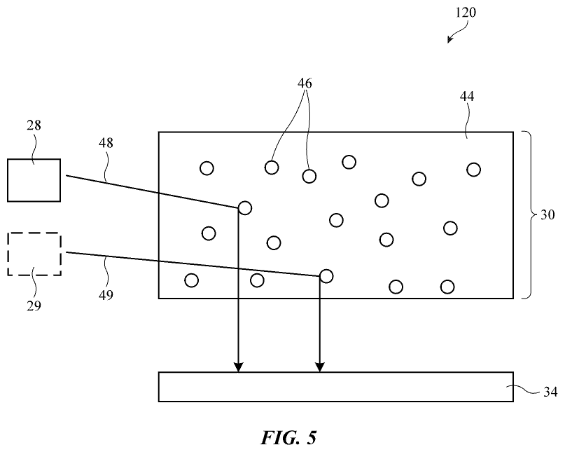

The use of interferometry to determine relative humidity shown in FIG. 4 is merely illustrative. In general, any measurement method may be used to determine the relative humidity using light that passes through a relative humidity-sensitive layer. For example, a relative humidity sensor that includes relative humidity-sensitive material with plasmonic nanoparticles may be used. An illustrative example is shown in FIG. 5.

As shown in FIG. 5, relative humidity-sensitive layer 30 of relative humidity sensor 120 may include nanoparticles 46 in binder 44. Nanoparticles 46 may be, for example, plasmonic nanoparticles that include gold nanoparticles, silver nanoparticles, and/or platinum nanoparticles. In general, nanoparticles 46 may be any suitable nanoparticles that scatter light emitted by light source 28.

Binder 44 may be a relative humidity-sensitive polymer layer, as an example. In general, binder 44 may be any suitable material that exhibits changes, such as refractive index changes, when the relative humidity changes.

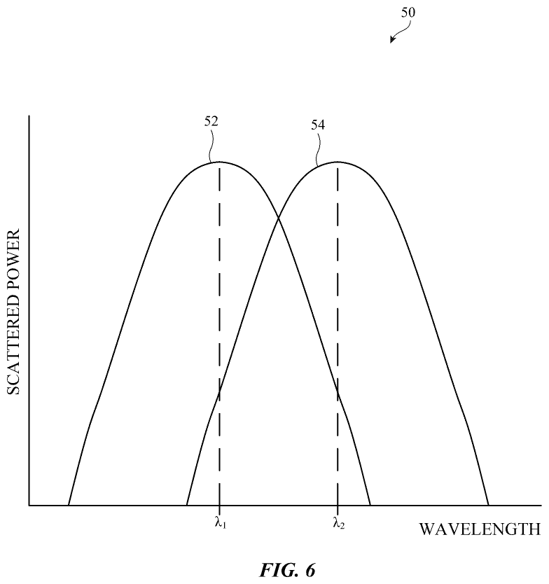

In operation, light source 28 may emit light 48 into relative humidity-sensitive layer 30. Light 48 may scatter from one or more of nanoparticles 46, and light detector 34 may detect the scattered light. In particular, light detector 34 may detect the power of the scattered light. Based on changes in the power of the scattered light, the relative humidity may be determined. In other words, relative humidity sensor 120 may determine the relative humidity directly based on the power of the scattered light, or control circuitry (such as control circuitry 112 of FIG. 3) may be used to determine the relative humidity based on the power of the scattered light. An illustrative graph showing a change in the power of the scattered light is shown in FIG. 6.

As shown in FIG. 6, graph 50 may include illustrative curves 52 and 54 of scattered power over different wavelengths. For example, curve 52 may represent the scattered light measured by light detector 34 at a first relative humidity, while curve 54 may represent the scattered light measured by light detector 34 at a second relative humidity. As shown, the peak wavelength λ₂ of curve 54 may be greater than the peak wavelength λ₁ of curve 52. This may be due to the refractive index change of relative humidity-sensitive material 30, which may cause plasmonic resonance changes, and/or may be due to shifts in the distance between nanoparticles 46 as binder 44 expands/contracts due to relative humidity changes. For example, curve 54 may be at a higher relative humidity than curve 52.

The relative humidity may be determined by taking a ratio of the scattered power at wavelength λ₁ to the scattered power at wavelength λ₂. In this way, plasmonic resonance may be used to determine a relative humidity.

Returning to FIG. 5, optional light source 29 may also be used to emit light into relative humidity-sensitive layer 30. In particular, light source 29 may emit light 49 into relative humidity-sensitive layer 30. Light 49 may have a different wavelength than light 48 emitted by light emitter 28, as an example. Light 49 may scatter from one or more of nanoparticles 46, and light detector 34 may detect the scattered light. In particular, light detector 34 may detect the power of the scattered light. By comparing the power shifts of scattered light 48 and scattered light 49, larger relative humidity changes may be measured and/or relative humidity sensor 120 may be more sensitive to relative humidity changes.

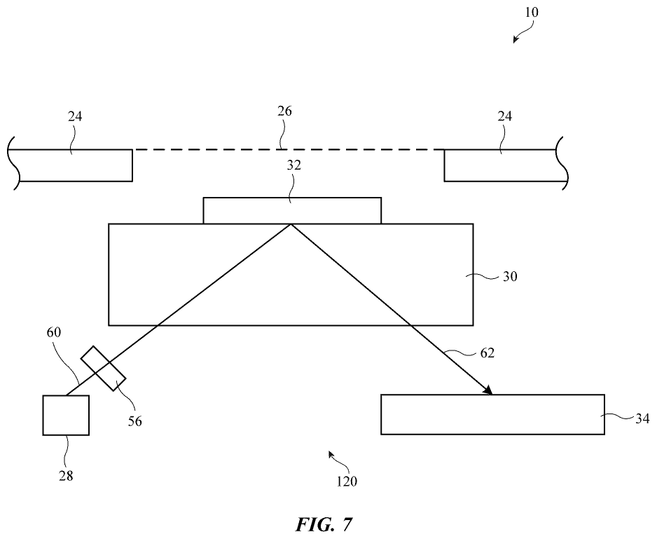

In other embodiments, light polarization may be used to determine the relative humidity. An illustrative example is shown in FIG. 7.

As shown in FIG. 7, electronic device 10 may include relative humidity sensor 120 with relative humidity-sensitive material 30. Relative humidity-sensitive layer 30 may be formed from birefringent material that exhibits polarization changes in response to relative humidity changes.

Polarizer 56 may overlap light emitter 28, and mirror coating 32 may be formed on an opposite side of relative humidity-sensitive layer 30 from light source 28. Relative humidity sensor 120 may also include light detector 34, which may be a polarization detector.

In operation, light emitter 28 may emit light 60 through polarizer 56 to polarize light 60. Polarized light 60 may pass through relative humidity-sensitive material 30 and reflect off of mirror coating 32 as light 62. Light detector 34 may detect light 62.

Because relative humidity-sensitive material 30 is birefringent with polarization that changes based on the relative humidity, the polarization of light 62 will depend on the relative humidity. Therefore, by measuring the polarization of light 62 using light detector 34, the relative humidity may be determined. In other words, relative humidity sensor 120 may determine the relative humidity directly based on the measured polarization of light 62, or control circuitry (such as control circuitry 112 of FIG. 3) may be used to determine the relative humidity based on the measured polarization of light 62.

Although not shown in FIG. 7, mirror coating 32 may be heated, such as using a built-in heater or a standalone heater, to avoid moisture from being trapped between mirror coating 32 and relative humidity-sensitive layer 30, if desired. However, the use of a heater to heat mirror coating 32 is merely illustrative. In general, relative humidity-sensitive layer 30 of any of FIGS. 4-7 may be heated to reduce the moisture within layer 30 between relative humidity measurements.

Additionally or alternatively, light emitter 28 and light detector 34 may be formed on a common control board, such as a printed circuit board, if desired.

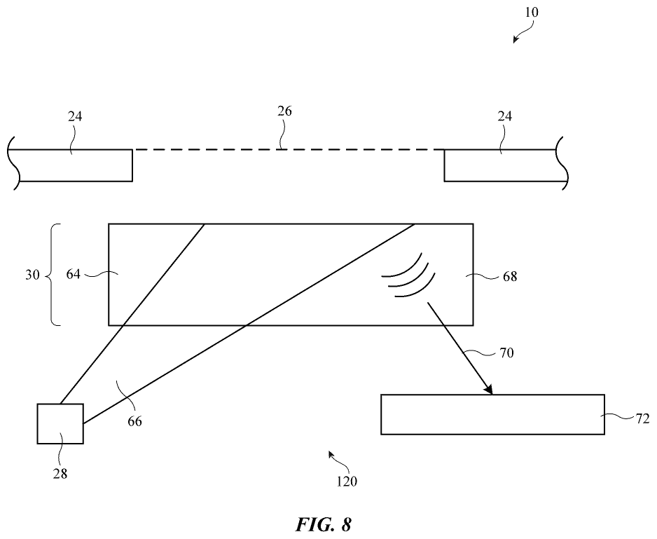

In the examples of FIGS. 4-7, a light detector is used to measure light that passes through relative humidity-sensitive material to determine relative humidity. However, these embodiments are merely illustrative. If desired, other sensors, such as an acoustic sensor, may be used to determine relative humidity. An illustrative example is shown in FIG. 8.

As shown in FIG. 8, electronic device 10 may include relative humidity sensor 120 that includes relative humidity-sensitive material 30 formed from water-absorbing material 64. Light emitter 28 may emit pulses of light 66 into water-absorbing material 64 at a wavelength in a water absorption band. For example, light 66 may have a wavelength of approximately 970 nm, of approximately 1200 nm, or of approximately 1450 nm, as examples. In some illustrative examples, light 66 may be near-infrared light in a water absorption band.

Because pulses of light 66 are in a water absorption band, acoustic waves 68 may be produced by thermal expansion from local heating as the pulses of light 66 travel through the water in water-absorbing material 64. In particular, the amount (e.g., the intensity) of acoustic waves 68 may depend on the water content in water-absorbing-material 64, and may therefore depend on the relative humidity.

Detector 72, which may be a microphone or other acoustic detector, may detect acoustic waves 68 as they travel in direction 70 to detector 72. By measuring the intensity/amount of acoustic waves 68, the relative humidity may be determined. In other words, relative humidity sensor 120 may determine the relative humidity directly based on the measured acoustic waves 68, or control circuitry (such as control circuitry 112 of FIG. 3) may be used to determine the relative humidity based on the measured acoustic waves 68.

Although FIG. 8 shows light emitter 28 emitting unfocused light 66 into water-absorbing material 64, this is merely illustrative. In some embodiments, light emitter 28 may emit pulses of focused light (either by emitting unfocused light through a lens or by including a dedicated lens within light emitter 28) into water-absorbing material 64 to form acoustic waves that may be detected by detector 72.

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is illustrative and various modifications can be made to the described embodiments. The foregoing embodiments may be implemented individually or in any combination.

What is claimed is:

1. An electronic device having an interior and an exterior that is exposed to an environment, the electronic device comprising:
a housing that separates the interior from the exterior, wherein the housing has an opening; and
a relative humidity sensor in the housing and exposed to the environment, wherein the relative humidity sensor comprises:
a relative humidity-sensitive layer;
a light emitter configured to emit light into the relative humidity-sensitive layer; and
a detector configured to generate relative humidity measurements.

2. The electronic device of claim 1, wherein the light emitter comprises a laser diode, the detector comprises a light detector, and the laser diode is further configured to emit additional light toward the light detector.

3. The electronic device of claim 2, wherein the laser diode is configured to emit the light into a first side of the relative humidity-sensitive layer, and the relative humidity sensor further comprises:
a mirror coating on a second side of the relative humidity-sensitive layer, opposite the first side.

4. The electronic device of claim 3, wherein the light detector is further configured to generate the relative humidity measurements interferometrically based on detected optical path lengths of the light and the additional light.

5. The electronic device of claim 4, wherein the relative humidity sensor further comprises:
a partial mirror coating on the first side of the relative humidity-sensitive layer.

6. The electronic device of claim 1, wherein the relative humidity-sensitive layer comprises plasmonic nanoparticles in a relative-humidity sensitive material.

7. The electronic device of claim 6, wherein the detector is a light detector that is configured to measure power changes of light scattered by the plasmonic nanoparticles to generate the relative humidity measurements.

8. The electronic device of claim 7, wherein the light emitter is configured to emit the light with a first wavelength, and the relative humidity sensor further comprises:
an additional light emitter configured to emit additional light with a second wavelength that is different from the first wavelength, and the light detector is configured to measure power changes of light scattered by the plasmonic nanoparticles at the first wavelength and the second wavelength to generate the relative humidity measurements.

9. The electronic device of claim 1, wherein the relative humidity sensor further comprises:
a polarizer that overlaps the light emitter and is configured to polarize the light, wherein the detector is a polarization detector that detects a polarization of the light that has passed through the relative humidity-sensitive layer.

10. The electronic device of claim 9, wherein the light emitter is configured to emit the light into a first surface of the relative humidity-sensitive layer, and the relative humidity sensor further comprises:
a mirror coating on a second surface of the relative humidity-sensitive layer, opposite the first surface, wherein the mirror coating is configured to reflect the light to the polarization detector.

11. The electronic device of claim 1, wherein the relative humidity-sensitive layer comprises a water-absorbing material.

12. The electronic device of claim 11, wherein the light emitter is configured to emit the light as pulsed light with a wavelength in a water absorption band to produce acoustic waves when the light heats water in the water-absorbing material, and the detector comprises a microphone that detects the acoustic waves.

13. The electronic device of claim 1, wherein the relative humidity-sensitive layer comprises a film that includes voids and metal-oxide nanoparticles.

14. A relative humidity sensor, comprising:
a relative humidity-sensitive layer;
a light emitter configured to emit light into the relative humidity-sensitive layer; and
a light detector configured to detect light that has passed through the relative humidity-sensitive layer to determine a relative humidity.

15. The relative humidity sensor of claim 14, wherein the relative humidity-sensitive layer comprises a polymer layer, and the light detector is configured to measure a path length of the light after it has passed through the polymer layer.

16. The relative humidity sensor of claim 14, wherein the relative humidity-sensitive layer comprises plasmonic nanoparticles in a relative humidity-sensitive material, and wherein the plasmonic nanoparticles are configured to scatter the light.

17. The relative humidity sensor of claim 16, wherein the light detector is configured to measure a power of the scattered light to determine the relative humidity.

18. The relative humidity sensor of claim 14, wherein the relative humidity-sensitive layer is configured to change a polarization of the light based on the relative humidity, and the light detector is configured to measure the polarization to determine the relative humidity.

19. An electronic device, comprising:
a housing;
a relative humidity sensor in the housing, wherein the relative humidity sensor comprises:
a relative humidity-sensitive layer that is configured to exhibit a change in refractive index in response to relative humidity changes;
a light emitter configured to emit light into the relative humidity-sensitive layer; and
a light detector configured to detect light that has passed through the relative humidity-sensitive layer; and
control circuitry that is configured to determine a relative humidity based on the light detected by the light detector.

20. The electronic device of claim 19, wherein the relative humidity-sensitive layer comprises a film that includes voids and metal-oxide nanoparticles.
